(19) United States
(12) Patent Application Publication
(10) Pub. No.: US 2005/0284315 A1
(43) Pub. Date: Dec. 29, 2005

(54) INTAGLIO OFFSET PRINTING MACHINE

(75) Inventors: Kun-Lang Yu, Keelung (TW); Chih-Sung Huang, Jhonghe City (TW)

Correspondence Address: NIKOLAI & MERSEREAU, P.A., 900 SECOND AVENUE SOUTH, SUITE 820, MINNEAPOLIS, MN, 55402, US

(73) Assignee: TOP DIGITAL CO., LTD., Hsichih City (TW)

(21) Appl. No.: 10/907,897

(22) Filed: Apr. 20, 2005

(30) Foreign Application Priority Data
Jun. 29, 2004 (TW) 93118995

(51) Int. Cl. B41F 9/01

(52) U.S. Cl. 101/154

(57) ABSTRACT

An intaglio offset printing machine includes a metal intaglio plate cylinder having a plurality of recesses in a circumference thereof and a transferring cylinder. Ink is filled into the recesses. The transferring cylinder presses against the metal intaglio plate cylinder, allowing the ink in the recesses of the metal intaglio plate cylinder to be transferred onto the transferring cylinder when the metal intaglio plate cylinder and the transferring cylinder are turned synchronously. The transferring cylinder presses against a surface of an object to be printed. Thus, the ink on the transferring cylinder is transferred onto the surface of the object passing through the transferring cylinder.

### BACKGROUND OF THE INVENTION

1. Field of the Invention

The present invention relates to a printing machine. In particular, the present invention relates to an intaglio offset printing machine.

2. Description of Related Art

FIGS. 1 and 1A of the drawings illustrate a conventional intaglio printing machine comprising a metal intaglio plate cylinder 10 and an impression cylinder 20 for carrying out direct printing. The plate cylinder 10 includes a plurality of recesses 111 into which ink is filled. A gap 12 is defined between the plate cylinder 10 and the impression cylinder 20, allowing passage of a soft, thin object 1 (such as a piece of paper for producing bills) to be printed. When the soft, thin object 1 to be printed is passing through the gap 12, the impression cylinder 20 impresses the soft, thin object 1, urging the soft, thin object 1 into the recesses 111 of the plate cylinder 10. As illustrated in FIG. 1A, the ink in the recesses 11 is fixed on the surface of the soft, thin object 1. An intaglio printing is thus carried out on the surface of the soft, thin object 1.

However, the metal intaglio plate cylinder 10 and the impression cylinder 20 are only suitable for carrying out printing on soft, thin objects, not suitable for printing on a surface of hard materials.

As illustrated in FIG. 2 of the drawings, an intaglio printing machine disclosed in U.S. Pat. No. 4,566,384 includes a distributing cylinder 14, a form roller 13, and a plate cylinder 10′. A printing plate 100 is provided on the plate cylinder 10′ and comprises an ink-repellent outer layer, a photo-sensitive layer laminated beneath the ink-repellent outer layer, and an elastic layer laminated beneath the photo-sensitive layer. The printing plate 100 includes a plurality of recesses 101 on a surface thereof. Ink is filled into the recesses 101.

In operation, the plate cylinder 10′ directly impresses a hard object 2 to be printed. The ink in the recesses 101 of the plate cylinder 10′ is fixed on the surface of the hard object 2, thereby completing the intaglio printing.

Although the printing plate 100 on the plate cylinder 10′ allows printing on a surface of a hard object, the printing result is still limited to poor matching in the deformation of the printing plate 100 and the deformation of the hard object 2. The ink is supplied into the recesses 101 of the printing plate 100 by wiping the printing plate 100, resulting in shortening of the life of the printing plate 100, as the printing plate 100 made of elastic material is damaged. After printing, a portion of the residual ink on the printing plate 100 is wiped off from the printing plate 100 while another portion of the residual ink on the printing plate 100 is wiped into recesses 101 of the printing plate 100, further shortening the life of the printing plate 100. The elastic coefficient of the printing plate 100 changes as the printing plate 100 is damaged by wiping. As a result, the image transcribed from the printing plate 100 onto the surface of the hard object 2 is unstable due to variation of the elastic coefficient of the printing plate 100. Namely, different images are generated through the same printing plate 100. The printing result is thus unstable and unsatisfactory.

### OBJECTS OF THE INVENTION

An object of the present invention is to provide an intaglio offset printing machine with excellent matching in a surface of a transferring cylinder of the intaglio offset printing machine and a surface of a hard object to be printed, thereby prolonging the life of the intaglio offset printing machine.

Another object of the present invention is to provide an intaglio offset printing machine that may carry out two different offset printing operations.

### SUMMARY OF THE INVENTION

An intaglio offset printing machine in accordance with the present invention comprises a metal intaglio plate cylinder including a plurality of recesses in a circumference thereof and a transferring cylinder. Ink is filled into the recesses. The transferring cylinder presses against the metal intaglio plate cylinder, allowing the ink in the recesses of the metal intaglio plate cylinder to be transferred onto the transferring cylinder when the metal intaglio plate cylinder and the transferring cylinder are turned synchronously. The transferring cylinder presses against a surface of an object to be printed. Thus, the ink on the transferring cylinder is transferred onto the surface of the object passing through the transferring cylinder.

The intaglio offset printing machine in accordance with the present invention may further include an impression cylinder for exerting a pressure to the transferring cylinder. A gap is defined between the impression cylinder and the transferring cylinder. The object to be printed is moved to pass through the gap for carrying out intaglio offset printing when the impression cylinder and the transferring cylinder are turned synchronously. Preferably, the transferring cylinder comprises an elastic sleeve mounted therearound. A surface of the elastic sleeve deforms when the metal intaglio plate cylinder presses against the transferring cylinder. Preferably, the elastic sleeve is made of rubber.

Preferably, the intaglio plate cylinder is an engraved metal plate.

The object to be printed may be soft and thin or hard.

Other objects, advantages and novel features of this invention will become more apparent from the following detailed description when taken in conjunction with the accompanying drawings.

### BRIEF DESCRIPTION OF THE DRAWINGS

FIG. 1 is a schematic sectional view of a conventional intaglio printing machine;

FIG. 1A is an enlarged view of a portion of the intaglio printing machine in FIG. 1;

FIG. 2 is a schematic sectional view of another conventional intaglio printing machine; and

FIG. 3 is a schematic sectional view of an intaglio offset printing machine in accordance with the present invention.

### DETAILED DESCRIPTION OF THE PREFERRED EMBODIMENT

Referring to FIG. 3, an intaglio offset printing machine in accordance with the present invention comprises a metal intaglio plate cylinder 10, an impression cylinder 20, and a transferring cylinder 30. The metal plate cylinder 10, the impression cylinder 20, and the transferring cylinder 30 are arranged in parallel. The metal intaglio plate cylinder 10 presses against the transferring cylinder 30, which, in turn, presses against the impression cylinder 20.

Still referring to FIG. 3, the metal intaglio plate cylinder 10 includes an engraved metal plate with a plurality of recesses 11 in a circumference thereof. The recesses 11 form a specific image. Ink may be filled into the recesses 11 by conventional wiping. The metal intaglio plate cylinder 10 is made of metal and thus not damaged by wiping. The metal intaglio plate cylinder 10 is driven to turn via an appropriate means. A tight contact is provided between the metal intaglio plate cylinder 10 and the transferring cylinder 30. Thus, the ink in the recesses 11 of the metal intaglio plate cylinder 10 can be transferred onto the transferring cylinder 30.

Still referring to FIG. 3, the impression cylinder 20 presses against the transferring cylinder 30 and thus provides a printing pressure to the transferring cylinder 30 suitable for improving the printing quality. A gap 31 is formed between the impression cylinder 20 and the transferring cylinder 30. When the impression cylinder 20 and the transferring cylinder 30 are turned synchronously, a hard object 20 is passed through the gap 31 for carrying out intaglio offset printing. The pressure from the impression cylinder 20 is directly imparted to the hard object 2.

Still referring to FIG. 3, an elastic sleeve 300 is mounted around the transferring cylinder 30. When the metal intaglio plate cylinder 10 presses against the transferring cylinder 30, an appropriate deformation is generated on the surface of the elastic sleeve 300 so as to move into the recesses 11 of the metal intaglio plate cylinder 10. Thus, when the metal intaglio plate cylinder 10 and the transferring cylinder 30 are turned synchronously, the ink 11 in the recesses 11 of the metal intaglio plate cylinder 10 is adhered to the surface of the elastic sleeve 300 of the transferring cylinder 30, forming an ink image 301 to be transferred. Preferably, the elastic sleeve is made of natural rubber, artificial rubber, or other elastic material. Alternatively, the elastic sleeve is made of a rubber blanket.

Still referring to FIG. 3, when the hard object 2 is passing through the gap 31, since the impression cylinder 20 presses against the surface of the hard object 2, the ink image 301 on the elastic sleeve 300 is transferred onto the surface of the hard object 2, completing the intaglio offset printing of the image on the surface of the hard object 2.

The intaglio offset printing machine in accordance with the present invention may only include a metal intaglio plate cylinder 10 and a transferring cylinder 30. Namely, the impression cylinder 20 can be omitted if desired. The transferring cylinder 30 presses against the surface of the hard object 2 for carrying out intaglio offset printing.

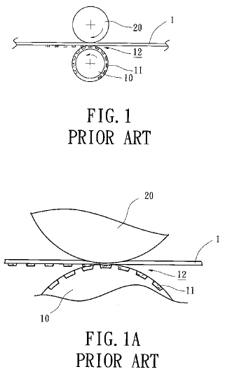

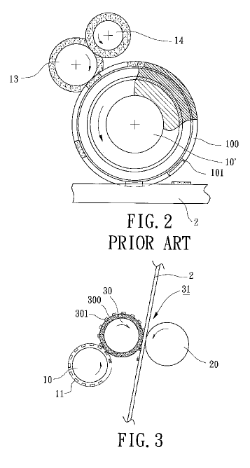

Referring to FIGS. 1 and 3, the metal intaglio plate cylinder 10 and the impression cylinder 20 according to prior art can only used to carry out printing on a soft, thin object 1, whereas the metal intaglio plate cylinder 10 and the transferring cylinder 30 and/or the impression cylinder 20 can be used to carry out printing on a hard object 2.

Further, the disadvantages of unstable printing effect and unsatisfactory printing effect of the intaglio printing machine disclosed in U.S. Pat. No. 4,566,384 is avoided by the intaglio offset printing machine in accordance with the present invention. Further, the intaglio offset printing machine in accordance with the present invention can be used to carry out printing on either soft or hard objects. Further, the life of the intaglio offset printing machine in accordance with the present invention is relatively long, as the metal intaglio plate cylinder is almost not damaged by the wiping operation for filling ink for printing purposes or for removing residual ink after printing.

While the principles of this invention have been disclosed in connection with a specific embodiment, it should be understood by those skilled in the art that these descriptions are not intended to limit the scope of the invention, and that any modification and variation without departing the spirit of the invention is intended to be covered by the scope of this invention defined only by the appended claims.

1. An intaglio offset printing machine comprising:
a metal intaglio plate cylinder including a plurality of recesses in a circumference thereof, with ink being adapted to be filled into the recesses; and
a transferring cylinder pressing against the metal intaglio plate cylinder, allowing ink in the recesses of the metal intaglio plate cylinder to be transferred onto the transferring cylinder when the metal intaglio plate cylinder and the transferring cylinder are turned synchronously, the transferring cylinder being adapted to press against a surface of an object to be printed, with the ink on the transferring cylinder being transferred onto the surface of the object passing through the transferring cylinder.

2. The intaglio offset printing machine as claimed in claim 1, further comprising an impression cylinder for exerting a pressure to the transferring cylinder, a gap being defined between the impression cylinder and the transferring cylinder, the object to be printed being moved to pass through the gap for carrying out intaglio offset printing when the impression cylinder and the transferring cylinder are turned synchronously.

3. The intaglio offset printing machine as claimed in claim 2, wherein the transferring cylinder comprises an elastic sleeve mounted therearound, and wherein a surface of the elastic sleeve deforms when the metal intaglio plate cylinder presses against the transferring cylinder.

4. The intaglio offset printing machine as claimed in claim 3, wherein the elastic sleeve is made of rubber.

5. The intaglio offset printing machine as claimed in claim 1, wherein the intaglio plate cylinder is an engraved metal plate.

6. The intaglio offset printing machine as claimed in claim 1, wherein the machine is suitable for printing on the object made from a soft and thin sheet.

7. The intaglio offset printing machine as claimed in claim 1, wherein the machine is suitable for printing on the object made from a soft or hard material.

8. The intaglio offset printing machine as claimed in claim 1, wherein the transferring cylinder comprises an elastic sleeve mounted therearound, a surface of the elastic sleeve deforms when the metal intaglio plate cylinder presses against the transferring cylinder.

9. The intaglio offset printing machine as claimed in claim 8, wherein the elastic sleeve is made of rubber, or elastic material.
